(19) United States
(12) Patent Application Publication
(10) Pub. No.: US 2008/0243858 A1
(43) Pub. Date: Oct. 2, 2008

(54) Design and Methods for a Distributed Database, Distributed Processing Network Management System

(75) Inventors: Rene Maria Buniel Dos Remedios, Muntinlupa City (PH); Joel Cruz Delos, Paranaque (PH); Erol Reynante Rempillo, Sta. Rosa (PH)

Correspondence Address: RENE MARIA B. DOS REMEDIOS, BLDG. 7, LOT 52, FTI COMPLEX, TAGUIG, NCR, 1630, PH

(73) Assignee: Latitude Broadband, Inc.

(21) Appl. No.: 11/461,455

(22) Filed: Aug. 1, 2006

(51) Int. Cl. G06F 17/30

(52) U.S. Cl. 707/10; 707/E17.032

(57) ABSTRACT

The design and methods for a distributed database, distributed processing implementation network management system are disclosed for packet-based networks, with emphasis on Next Generation Networks (NGN) involving numerous network devices. The invention presented in this document runs under the paradigm of a regionalized or zonal network management architecture, where the entire managed network is divided into zones. Every zone, comprising of a group (or groups) of network devices, has a designated autonomous network management substation which can periodically collect data from the network devices in its respective zone, report alerts of detected network device failures, and temporary store the current and most recent data until a defined time. A central database also exists as storage for the old and historical data. The network administrator retrieves current data and historical data from the network substations and the central database, respectively, through a central network management station which is the overseer of all the zones, automatically keeping track of every network device and zone association mapping.

The invention is carefully designed to minimize computational load, database load, and network traffic in all components of the management system while not compromising the security and speed of data retrieval. Scalability is kept in mind so that the system can support complex, large, and growing networks.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

The design and methods for a distributed database, distributed processing implementation network management system are disclosed for packet-based networks, with emphasis on Next Generation Networks (NGN) involving numerous network devices. The invention presented in this document runs under the paradigm of a regionalized or zonal network management architecture, where the entire managed network is divided into zones. Every zone, comprising of a group (or groups) of network devices, has a designated autonomous network management substation which can periodically collect data from the network devices in its respective zone, report alerts of detected network device failures, and temporary store the current and most recent data until a defined time. A central database also exists as storage for the old and historical data. The network administrator retrieves current data and historical data from the network substations and the central database, respectively, through a central network management station which is the overseer of all the zones, automatically keeping track of every network device and zone association mapping.

The invention is carefully designed to minimize computational load, database load, and network traffic in all components of the management system while not compromising the security and speed of data retrieval. Scalability is kept in mind so that the system can support complex, large, and growing networks.

### BACKGROUND OF THE INVENTION

As all communications networks rapidly shift to packet-based systems, the diversity of devices and technologies used to create those networks increases. Failures are inevitable when trying to make such diverse systems work together. It is impossible for human operators to constantly monitor an entire network that spans a very large geographical area and includes thousands of elements. Network management systems are the tools fitted to efficiently monitor and handle abnormal situations that arise in a given network.

The goal of network management is to ensure that network elements and resources are operating efficiently to provide the best possible services to end-users. This is done by monitoring the status, health, and utilization of each element that makes up the network. The data gathered can then be analyzed to determine the best action to take to keep the network running smoothly. In the event that a network element fails, such failure must be detected as soon as possible so that corrective actions can be performed. It is desired that element failures be detected and remedied before problems escalate and disrupt network operations.

An intelligent network management system not only detects failed events but can also offer a recorded footprint of element behavior prior to its failure through a historical summary of data stored in a database. The historical database will enable the network operators to do statistical analysis of the network element under observation.

Early models of network management systems operate under a centralized paradigm, where all operations and data storage are dictated and controlled by a single manager element. This is ideal for small networks since it does not introduce unnecessary complexity. However, the load imposed on a central manager becomes huge as the network grows in size. Eventually, the computational load becomes too large, putting all processes under the mercy of the central manager's hardware. Also, the overhead management traffic flowing between the central manager and the network elements contributes to network congestion.

The obvious solution is to off-load the central manager by distributing tasks to several lower layer managers, each with a designated zone or domain of network elements to handle. A group of lower layer managers will then report to their upper layer manager, where the control of the management system resides. Models of this hierarchical architecture already exist as the claims disclosed by Gang Fu (Patent # 2004/0196794) where the communication and data gathering protocol relies on Simple Network Management Protocol (SNMP). This model effectively addresses scalability of network management.

However, fast growing networks such as the emerging NGN, specially those operating with a last-mile wireless broadband access for example, involves various network devices and resources to manage. These networks demand a monitoring and management system capable of fast aggregation of huge amount of data from thousands of network elements in real time and will require more than SNMP on a distributed hierarchical architecture. It is recommended to provide a solution that is not only scalable but shall also meet the requirements of fast assemblage and fast retrieval of multiple data for a particular network element in real time manner.

Throughout this document, the term Access Control Manager or ACM refers to an intermediate network device equipment that can be a router, bridge, or NAT device; or an Access Controller as defined in the patent application entitled “Methods and Systems for Call Admission Control and Providing Quality of Service in Broadband Wireless Access Packet-Based Networks” by Dos Remedios et al. The Access Controller implements functions integral to an NGN such as access transport functions like bandwidth management, packet filtering, and traffic scheduling and prioritization. The elements of the network management system defined in this application can be incorporated in said Access Controller.

### SUMMARY OF THE INVENTION

The network management system disclosed in this paper is a database-driven management system incorporated in a distributed probe array architecture.

The management system involves distributed autonomous network manager stations, referred according to this invention as Probe Stations, where each Probe Station is responsible for monitoring and management of its designated group of network elements defined as a Zone. A Probe Station periodically polls, in a predetermined interval, the network devices under its respective zone, for raw data and then process it into a more useful form for storage in a small Structured Query Language (SQL) database residing within itself. Probe Stations are repositories only for recent data and hold them in a defined span of time before it gets transferred to a Central Database for archiving. The Central Database houses historical data of all network devices for future reference. The network administrator can retrieve recent data from the Probe Stations as well as historical data from the Central Database through secure database queries initiated from a Central Network Management Station which is the overseer of all Probe Stations and the Central Database. In the event that a network device is added (automatically or manually) in a particular Zone, the Probe Station designated to said Zone will send a Network Device Zone Association Update to the Central Network Management Station to inform it of the changes. The Probe Station is also responsible for reporting alerts and warnings to the Central Network Management Station in an event of a network device malfunction, link disruption, or network resource depletion is detected. Communications and data transfer between the Probe Stations, the Central Database, and the Central Network Management Station run under secure data transfer protocols such as Secure Sockets Layer (SSL) or Transport Layer Security (TLS) protocol.

### BRIEF DESCRIPTION OF ILLUSTRATIONS

A more detailed understanding of the operation of the network management system may be obtained by studying the figures in this paper. The examples serve to illustrate possible scenarios where the invention is most useful. They do not in any way limit the scope of the invention.

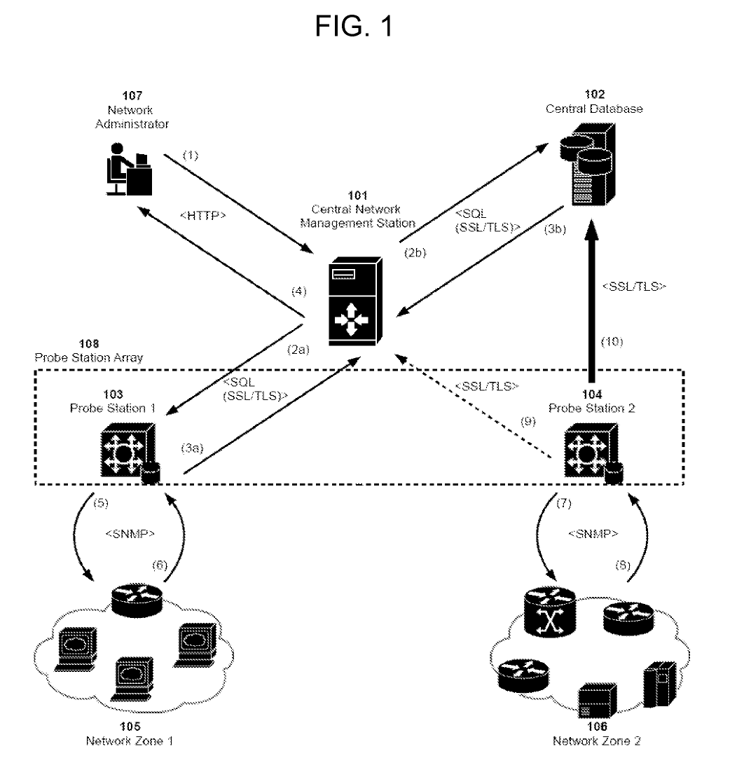

FIG. 1 shows the system diagram of the network management system according to this invention.

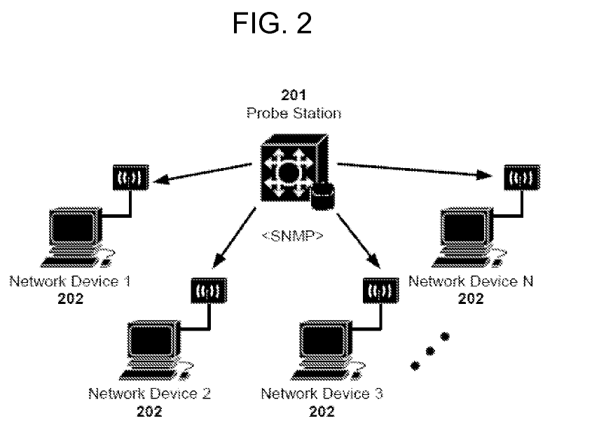

FIG. 2 shows the diagram of a Probe Station directly managing the network devices under its scope.

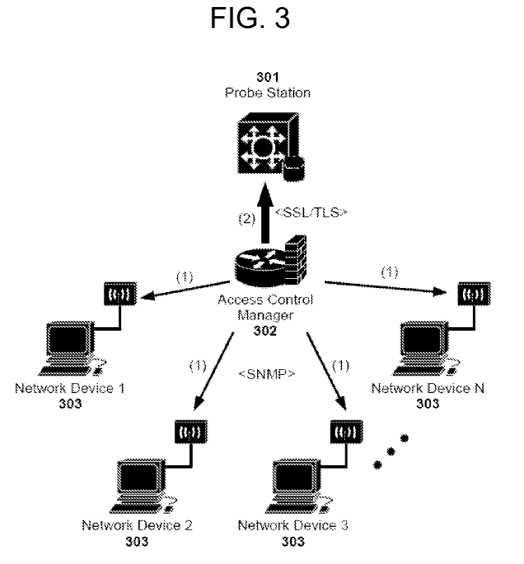

FIG. 3 shows the diagram of a Probe Station with an intermediate network device equipment (ACM).

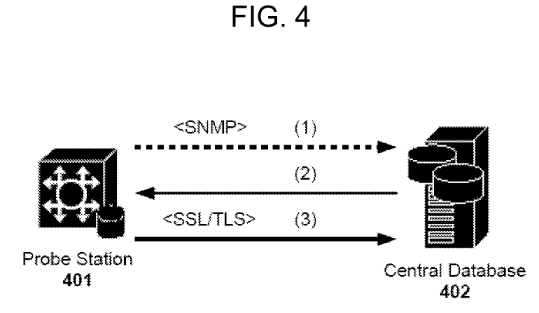

FIG. 4 shows the control messaging between a Probe Station and a Central Database during archive data transfer.

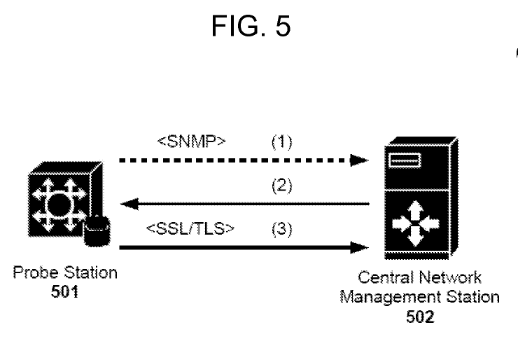

FIG. 5 shows the control messaging between a Probe Station and a Central Network Management Station during network device zone association updates, and event alerts.

### DETAILED DESCRIPTION OF THE INVENTION

The next statements discusses the present invention in detail, in reference with the accompanying illustrations.

The overall network system diagram presented in FIG. 1 has three main management sections—1) The Central Network Management Station 101, which is the gateway of the Network Administrator 107 in managing the whole network; 2) The Central Database 102, which is a large database holding historical data of all the network device elements; 3) The Probe Station Array 108 comprised of Probe Stations 103 and 104, each having their respective Zones of network elements (105 and 106) to handle.

Referring to FIG. 1, the process whereby the Network Administrator 107 views the current status or the historical data of a particular network device he wishes to examine follows the following protocol:
Transaction (1): The Network Administrator 107 sends an inquiry for a particular network device to the Central Network Management Station 101 through web interface.
Transaction (2):
Case A: If the inquiry requires current data, the Central Network Management Station 101 determines, through a lookup table, that the target device is under the Zone of Probe Station 103, and sends an SQL query.
Case B: If the inquiry requires historical data, the SQL query is sent to the Central Database 102.
Transaction (3):
Case A: Probe Station 103 returns the requested current data to Central Network Manager Station 101.
Case B: The Central Database 102 returns the requested historical data to Central Network Manager Station 101.
Transaction (4): The Central Network Management Station 101 presents the data retrieved from Probe Station 103 or from the Central Database to Network Administrator 107, as an HTML page viewed in a web browser.

The SQL transactions mentioned in [20] and [21] runs with SSL support.

In cases where the Network Administrator wishes to have an overview of the current status of entire network, the Central Network Management Station will return the HTML pages one Zone per page, based on the defined groupings of network elements. The procedure follows what is outlined from [19] to [22].

Transactions (5) and (6) denotes the network element polling cycles performed by Probe Station 103 to network element group 105. The same routine is performed simultaneously by Probe Station 104 to network element group 106, having polling cycles (7) and (8).

The polling cycles are shown closely by FIG. 2 and FIG. 3.

FIG. 2 is an illustration of a direct handling of Probe Station 201 to various network elements 202, polled one by one for data using SNMP. In this illustration, the network elements are the end-users or the subscribers of the network. This probe placement architecture is ideal for small networks where the routers in front of the end-devices can run the Probe Station application.

FIG. 3 is an illustration where an autonomous Probe Station 301 is placed one level up an intermediate network device. In the example of FIG. 3, the intermediate network device is a Access Control Manager 302, which is a NAT device. The data gathering procedure in this architecture are as follows, referring to FIG. 3:
Transaction (1): Access Control Manager 302 shall perform the polling routine behind the NAT of the Probe similar to what is described in [27].
Transaction (2): The Access Control Manager 302 will then forward the gathered data to Probe Station 301 using a file transfer protocol running under SSL.

It can be realized that the architecture as stated in [28] and shown by FIG. 3 can be expanded to a defined number of Access Control Managers all performing the same routine as with [29] and [30].

The archiving of data from a Probe Station to the Central Database is performed if the predefined time of data storage of a Probe Station already elapsed. This is generally denoted in FIG. 1 as transaction (10) initiated by Probe Station 104. This is shown in detail by FIG. 4, explained as follows:
Transaction (1): An SNMP trap is sent by Probe Station 401 to Central Database 402, as an information signal that it wants to transfer its data. Prior to sending the trap, it will export the data to a flat CSV file and will truncate the database in the process, to make way for fresh data.
Transaction (2): The Central Database 402, upon receipt of the trap, issues a file retrieval request to Probe Station 401.
Transaction (3): Probe Station 401 sends the file to the Central Database 402 for loading to the central database.

The file transfer protocol stated in [34] and [35] runs under SSL.

Alteration of network element zone association is also addressed by the system. This means that automatic addition of network devices to a certain zone or transfer of a network device from one zone to another is permitted without disrupting the operation of any of the sections of the Network Management System. This is because of the Network Element Zone Association Updates sent by Probe Stations to the Central Network Management Station as generally denoted by transaction (9) in FIG. 1. The control messages in this event follows what is shown in FIG. 5 and is described as follows:
Transaction (1): In event of an addition of a network device to a particular zone, either automatically or manually, the involved Probe Station 501 sends an SNMP trap to the Central Network Management Station 502, as an information signal that its Zone Association table needs to be updated.
Transaction (2): The Central Network Management Station 502 responds with an information retrieval request to Probe Station 501 of the alteration details.
Transaction (3): The Probe Station 501 sends back the information regarding the updates.

The information transfer stated in [39] and [40] is running under SSL.

The process of reporting alerts of network device failures and network resource depletion follows the same control messages and protocol described by FIG. 5, and is explained in detail as follows:
Transaction (1): Immediately after a failure or abnormality in a particular Zone is detected by its respective Probe Station 501, an SNMP trap is sent to the Central Network Management Station 502.
Transaction (2): The Central Network Management Station 502 upon receipt of the trap, shall respond with information retrieval request to Probe Station 501.
Transaction (3): Probe Station 501 sends back the alert details to the Central Network Management Station where this alert is transformed to visual warning displayed as an HTML page to the Network Administrator.

The invention presented in this document effectively addresses several vital issues in a complex IP network such as the NGN BWA which requires intensive collection of numerous data in real time. The first strong characteristic of the present invention is its database-driven environment allowing fast retrieval of a set of data, and enables storage of data for statistical analysis. The enormous loading dealt by simultaneous read and write of huge amount of data in a single database is greatly minimized by distributing the crucial database tables to the Probe Array. Near-real time acquisition of current data from network devices is achieved because the polling cycle is shorter as the size of the Zone designated to each Probe Station. Data Summary generation as well as CPU-intensive graph generation is performed at the Probe Stations making a huge task for a single machine be distributed. The data and information transfers are all implemented under SSL making the system secure. Management of the entire network is organized because of the inherent zoning characteristic implemented in Probe Arrays, where a Zone can be a geographic region. Rezoning of the entire network can be done without altering internal applications. Alerts are always passively reported to the Central Network Management Station and is presented as visual warnings.

1. A database-driven network management system which involves a plurality of Probe Stations fashioned as an Array; Each Probe Station is designated with a defined group of network devices known as a zone, where current data gathered from the network elements under a zone is stored in a SQL database residing within its particular Probe Station; A Central Database archives the historical data of the network elements of the entire network; A Central Network Management Station is the gateway gun of the network administrator where all the data inquiries originate and where the alert reports of the Probe Array are directed.

2. The system according to claim 1, wherein said SQL database inside the Probe Station holds only the current and most recent data until a predefined time, where these data are transferred to a Central Database for archiving when said defined time expires.

3. The system according to claim 2, wherein said data transfers are initiated by the Probe Stations.

4. The system according to claim 1, wherein initial computation, evaluation, summary of raw data, and graph generation is performed in the Probe Station.

5. The system according to claim 1, where the data gathering mechanism of the Probe Station can be inherited by an Intermediate Network Equipment, which can be a router, bridge, NAT device, or a bandwidth managing device. The collected data is then transferred to the Probe Station for initial processing and storage.

6. The system according to claim 1, wherein the Central Network Management Station is the overseer of the Probe Array and the Central Database, where a lookup table is maintained for Network Device Zone Association mapping.

7. The system according to claim 6, wherein the update of the Network Device Zone Association mapping table is initiated by the Probe Station managing the updated Zone.

8. The system according to claim 7, where said updated Zone refers to Zones where network devices have been added automatically or manually.

9. The system according to claim 1, wherein the detection of network malfunction and resource depletion is done by the Probe Station.

10. The system according to claims 1,2, and 5, wherein said data transfers and inquiries are implemented using secure data transfer protocols.
